(19) United States
(12) Patent Application Publication
(10) Pub. No.: US 2021/0248554 A1
(43) Pub. Date: Aug. 12, 2021

(54) SYSTEMS AND METHODS FOR NETWORK-BASED MULTI-LOCATION INVENTORY MANAGEMENT

(71) Applicant: Honeywell International Inc., Morris Plains, NJ (US)

(72) Inventors: Chris ROBERSON, Peoria, AZ (US); Susan BARLOW, Chandler, AZ (US)

(73) Assignee: Honeywell International Inc.

(21) Appl. No.: 16/783,340

(22) Filed: Feb. 6, 2020

(51) Int. Cl. G06Q 10/08; G06F 16/953

(52) U.S. Cl. CPC G06Q 10/0875; G06F 16/953

(57) ABSTRACT

A computer-implemented method for inventory management may comprise creating, by a processor, a plurality of lists of inventory excess and inventory shortage, wherein each of the plurality of lists corresponds to an inventory source of a plurality of inventory sources; comparing the plurality of lists to one another; determining instances in which at least a first of the plurality of inventory sources has an inventory excess and at least a second of the plurality of inventory sources has an inventory shortage; developing a transfer list; and executing the transfer list to complete at least one transfer.

### TECHNICAL FIELD

Various embodiments of the present disclosure generally relate to automated management of inventory and, more specifically, to automated measurement of inventory excesses and shortages across multiple sources of inventory.

### BACKGROUND

Inventory may be stored across multiple warehouses or other inventory storage locations. The same part may be stored at multiple locations. When a shortage of a part exists in a given storage location, production of an assembly using the part may be delayed until that storage location is restocked with that inventory item. Manufacture of a part may be stalled where even one part is not in stock at the storage location. Meanwhile, other storage locations may have an excess stock of the part, and the excess stock may go unused.

The present disclosure is directed to addressing one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed for using multi-location inventory management.

In one example, a computer-implemented method for inventory management may comprise creating, by a processor, a plurality of lists of inventory excess and inventory shortage, wherein each of the plurality of lists corresponds to an inventory source of a plurality of inventory sources; comparing the plurality of lists to one another; determining instances in which at least a first of the plurality of inventory sources has an inventory excess and at least a second of the plurality of inventory sources has an inventory shortage; developing a transfer list; and executing the transfer list to complete at least one transfer.

In another example, a system for executing a method for inventory management may comprise: creating, by a processor, a plurality of lists of inventory excess and inventory shortage, wherein each of the plurality of lists corresponds to an inventory source of a plurality of inventory sources; comparing the plurality of lists to one another; determining instances in which at least a first of the plurality of inventory sources has an inventory excess and at least a second of the plurality of inventory sources has an inventory shortage; developing a transfer list; and executing the transfer list to complete at least one transfer.

In yet another example, a non-transitory computer-readable medium may contain instructions for inventory management, the instructions comprising a method for: creating, by a processor, a plurality of lists of inventory excess and inventory shortage, wherein each of the plurality of lists corresponds to an inventory source of a plurality of inventory sources; comparing the plurality of lists to one another; determining instances in which at least a first of the plurality of inventory sources has an inventory excess and at least a second of the plurality of inventory sources has an inventory shortage; developing a transfer list; and executing the transfer list to complete at least one transfer.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary network environment for multi-location inventory management.

FIG. 2A-2B depict exemplary processes for multi-location inventory management using the network environment and system of FIG. 1.

FIGS. 3A-3B depict exemplary inventory and transfer lists that may be generated during the processes of FIGS. 2A and 2B.

FIG. 4 depicts an example computer system.

### DETAILED DESCRIPTION OF EMBODIMENTS

Generally, the examples described herein relate to automated management of inventory across multiple inventory storage locations (e.g., warehouses). An entity may have inventory items stored in multiple storage locations. The storage locations may be located in the same city or otherwise in somewhat close proximity to one another. The same part(s) may be stored at multiple storage locations. In order to assemble a part, parts may be required with a specified lead time.

The disclosed methods may be used to determine whether there will be a shortage of a part at a particular location at the specified lead time. The methods may further determine whether there will be a surplus of the part at another storage location at the lead time. If it is determined that one location will have a surplus of the part that another location will have a shortage of, then a bot may be deployed to order a stock transport to move the part from the location with the surplus to the location with the deficit. The disclosed methods may be performed, for example, in SAP. This prospective inventory management may prevent or minimize delays in manufacturing a part that result from shortages at the lead time.

In the following description, embodiments will be described with reference to the accompanying drawings. The terminology used in this disclosure may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a” and “an” include plural referents unless the context dictates otherwise. The term “exemplary” is used in the sense of “example” rather than “ideal.” The terms “information,” “data,” and “content” may be interchangeable when permitted by context. The terms “record” and “store,” in the sense of recording or storing data, may be interchangeable when permitted by context. The terms “comprises,” “comprising,” “includes,” “including,” and other variations thereof, are intended to cover a non-exclusive inclusion such that a process, method, or product that comprises a list of elements does not necessarily include only those elements, but may include other elements not expressly listed or inherent to such a process, method, article, or apparatus.

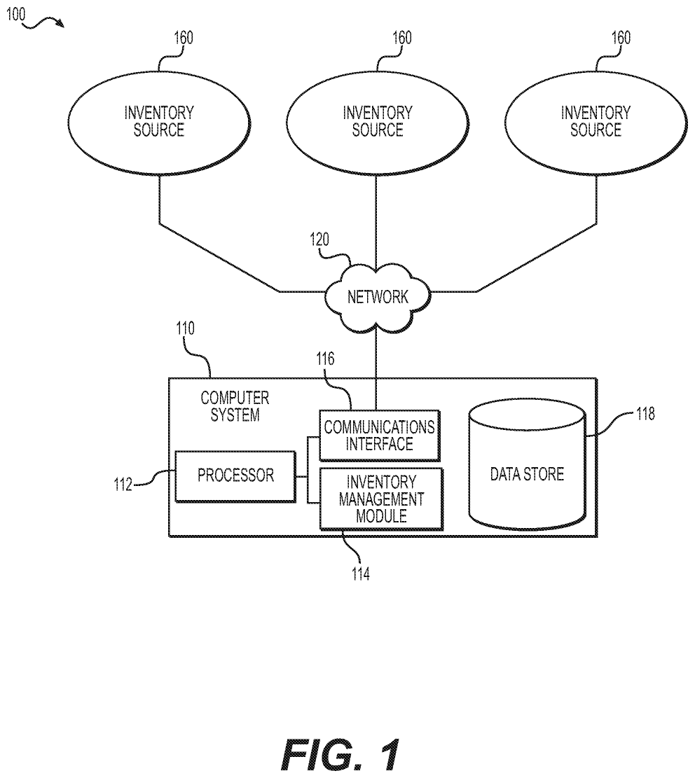

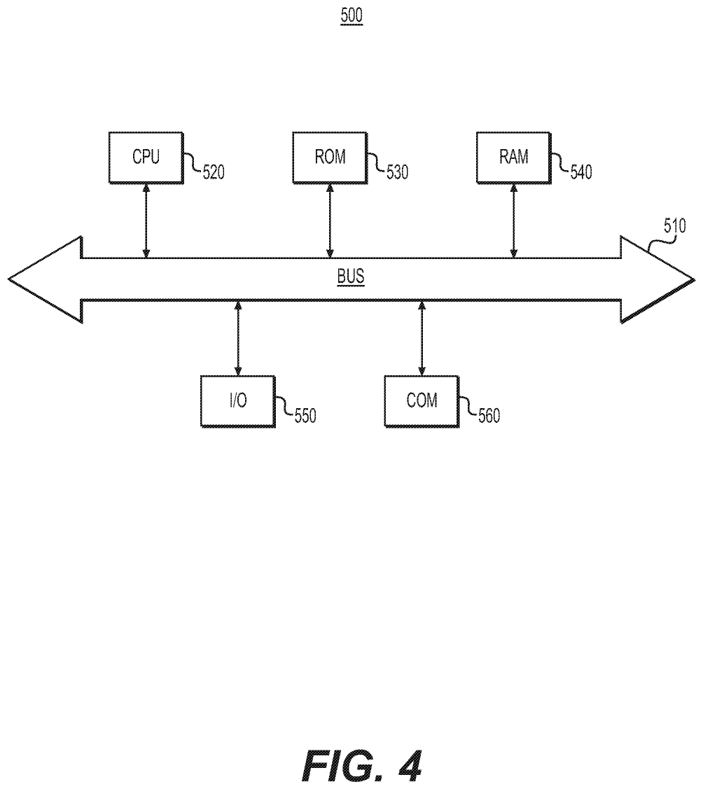

Referring now to the appended drawings, FIG. 1 illustrates an exemplary network environment and system 100 for management of inventory. A computer system 110 may have any of the properties of system 500, depicted in FIG. 4, and described in further detail below. In this disclosure, the term “computer system” generally encompasses any device or combination of devices, each device having at least one processor that executes instructions from a memory. Additionally, a computer system may be part of another computer system. Computer system 110 may include a processor 112, an inventory management module 114, a communications interface 116, and a data store 118 (e.g., hard drive). Alternatively, data store 118 may be omitted, and data storage may be cloud-based. Inventory management module 114 includes instructions for completing the methods described herein. Inventory management module 114 may be a specialized module configured to perform only the inventory management methods described herein, or inventory management module 114 may be a multi-functional module that also performs other methods, including methods not explicitly disclosed herein. Inventory management module 114 may have processing functions and/or may include storage for instructions. Inventory management module 114 is shown as a separate module but may be a component of processor 112 and/or data store 118.

Communications interface 116 or another component may be in communication with inventory management module 114 and a network 120. Network 120 may be a communications network. Network 120 may be a public network (such as the Internet), a private network, or a network comprising a combination of public and private network elements. Communication between computer system 110 and inventory sources 160 (described in further detail below) may be via satellite communications (e.g., SATCOM), cellular networks, Wi-Fi (e.g., IEEE 802.11 compliant), WiMAx (e.g., AeroMACS), optical fiber, and/or air-to-ground (ATG) network, and/or any other communication links now known or later developed.

A plurality of inventory sources 160 may be in communication with computer system 110 via network 120. Although FIG. 1 depicts three inventory sources 160, any appropriate number of inventory sources may be utilized. Inventory sources 160 may be electronic representations of inventory in a physical storage location (e.g., a computer having any of the features of computer system 110 or a data store (e.g., a database)). Inventory sources 160 may have information regarding an inventory stored in a physical inventory storage location. Each of inventory sources 160 may correspond to one physical inventory storage location. Inventory sources 160 may be housed within their respective physical inventory storage locations. Alternatively, inventory sources 160 may be physically housed in the same location as computer system 110, at another site, or in the cloud. The physical inventory storage locations represented by inventory sources 160 may be in a geographical area such that it is possible to travel between/among inventory sources 160 in a certain amount of time (e.g., in minutes, hours, days, etc.). For example, the physical inventory storage locations may be located in the same city, metropolitan area, or state.

Each inventory source 160 and corresponding physical inventory storage location may be associated with one or more manufacturing facilities. In order to construct a part, the manufacturing facility/facilities may source parts from a single inventory storage location. If the inventory storage location lacks a necessary part, manufacturing may be delayed until the part is restocked. However, that same part may also be stored in other storage locations, associated with other inventory sources 160.

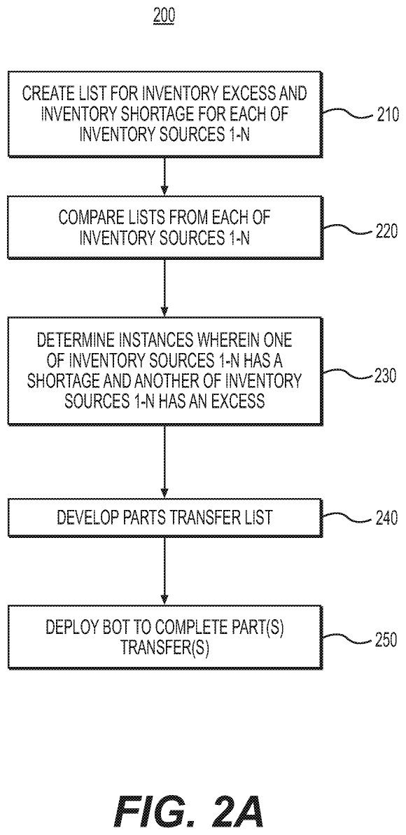

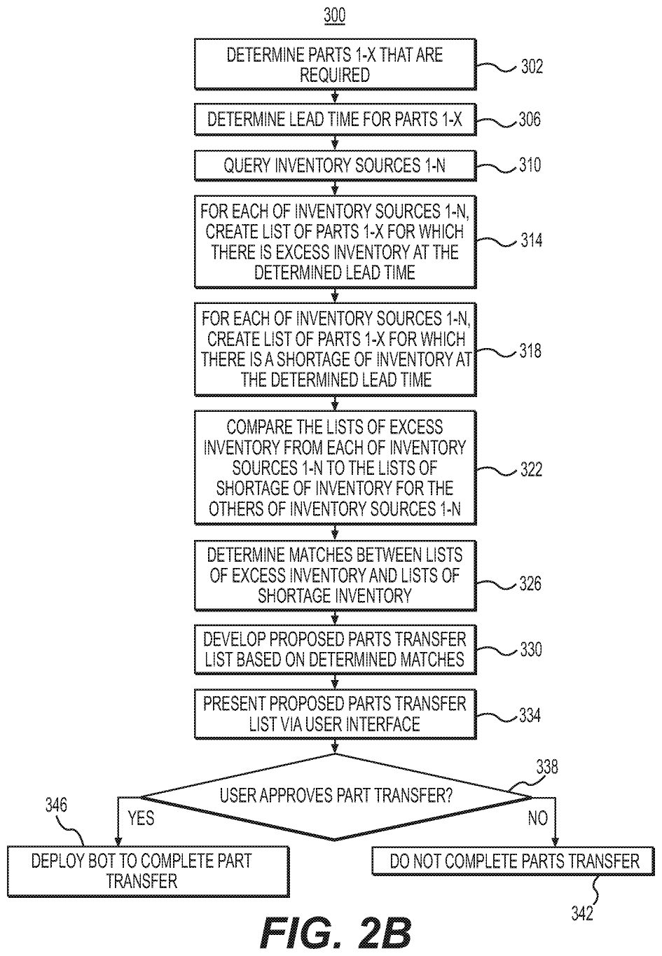

The method of FIG. 2A depicts a method 200 for managing inventory among multiple inventory sources 160 (and, in turn, multiple physical inventory storage locations). Each of these steps may be completed by inventory management module 114 or another portion of computer system 110. Alternatively, other components of system 100 (e.g., inventory sources 160) may complete certain tasks. Where appropriate, the description below indicates where components of system 100 other than computer system 110 may be particularly suited to complete the step.

In step 210, a list may be created of inventory excess and inventory shortage for each of inventory sources 160 (inventory sources 160 may be numbered 1-n). Step 210 may be completed by computer system 110, based on information obtained from inventory sources 160. Alternatively, inventory sources 160 themselves may complete step 210. The created list may include information regarding numbers of parts present in a particular physical storage location. The information for the lists of step 210 may be obtained from SAP, for example. Parts may be identified by information such as part number, part name, barcode, or any other suitable mechanism.

The list created may have a temporal aspect. For example, the created list may include information regarding a number of parts present in the physical storage location represented by inventory source 160 at the current time. Alternatively, the created list may include information regarding a number of parts present at a given future time (e.g., a lead time). For example, the relevant time may be the time at which the part is needed to assemble an assembly. The relevant lead time may be the same for each of the parts of an assembly to be manufactured. Alternatively, the relevant lead time may vary across the parts, because certain parts may be needed earlier than others. The list created in step 210 may list inventory numbers of all parts in the physical storage location at a particular lead time. The created list may account for part usage prior to the lead time and/or for incoming inventory prior to the lead time. The created list may also account for inventory needs after the lead time (e.g., shortly after the lead time), as discussed below.

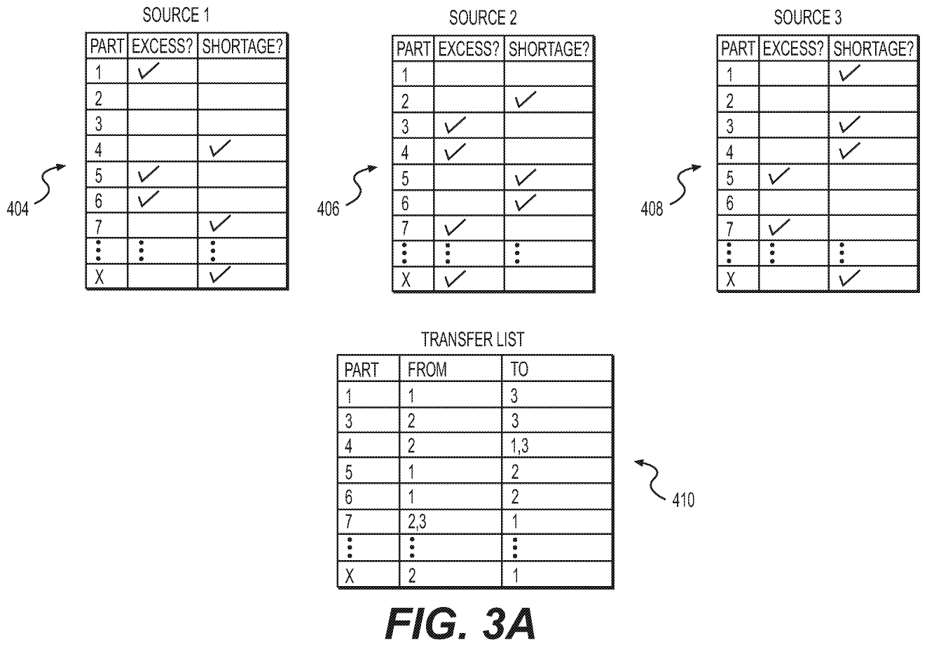

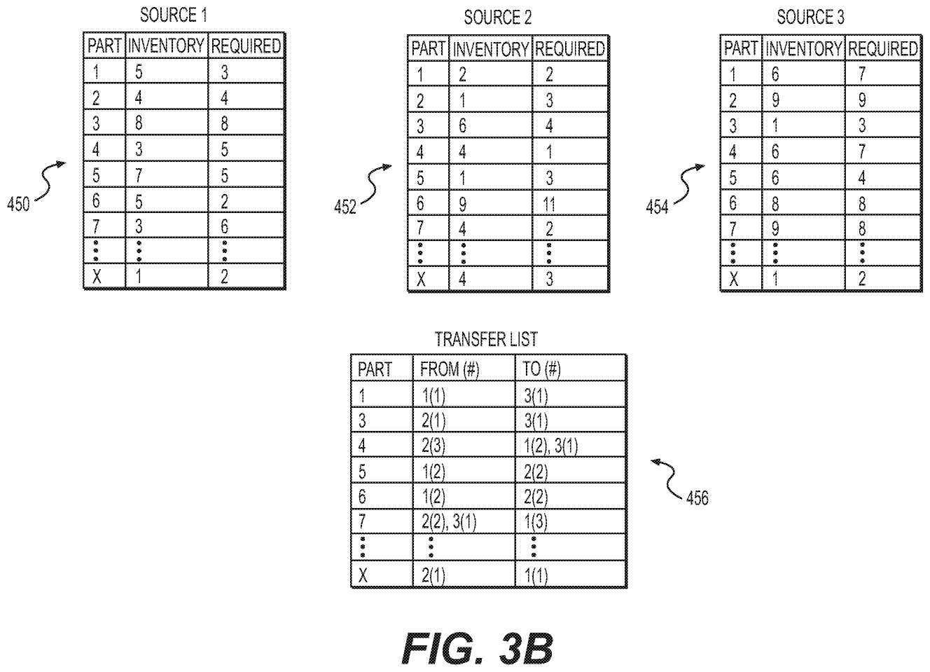

FIGS. 3A and 3B depict examples of information that may be on lists created in step 210. The data shown in FIGS. 3A and 3B is merely an example representation of the data that may be collected and the list that may be created. A list created in step 210 of method 200 may include more or less information than is shown in FIGS. 3A and 3B. As shown in FIGS. 3A and 3B, lists for each of inventory sources 160 may be compiled. FIGS. 3A and 3B show inventory lists 404, 406, 408 for three inventory sources, source 1, source 2, and source 3, respectively. However, lists may be created for any number of inventory sources. Three sources are shown in FIGS. 3A and 3B for ease of illustration. As shown in FIG. 3A, lists 404, 406, 408 may include a part identifier (the “part” column), whether there is excess of the part at the relevant lead time (shown by a checkmark in the “excess?” column), and whether there is a shortage of the part at the relevant time (shown by a checkmark in the “shortage?” column). As shown in FIG. 3B, lists 450, 452, 454 may be compiled from three inventory sources: source 1, source 2, and source 3, respectively. Lists 450, 452, 454 may include a part identifier (the “part” column), an amount of the part in inventory at the relevant lead time (the “inventory” column), and an amount of the part that is required at the relevant lead time. Lists 404, 406, 408 are not mutually exclusive with lists 450, 452, 454, and aspects of the different lists may be combined. The lists of parts 1-X may represent the parts required for a particular assembly at the lead time. Alternatively, the lists of parts 1-x may represent the entire inventory of each of inventory sources 160.

In step 220, the lists created in step 210 may be compared to one another. For example, the lists of step 210 may be combined to form one list compiling information from each of the lists. Alternatively, separate lists may be maintained. The rows and/or columns of the lists may be standardized so that the lists may be easily compared.

In step 230, a component of system 100 (e.g., computer system 110) may determine instances where one of inventory sources 160 has a shortage of inventory of one or parts and another of inventory sources 160 has an excess of inventory of one or more parts, using the lists of step 210 and/or the comparison of step 220. FIGS. 3A and 3B show various exemplary permutations in which inventory sources 160 may have an excess, shortage, or neither an excess nor a shortage of a given part. For example, comparing lists 404, 406, and 408 of FIG. 3A, it may be seen that, for part 1, source 1 has an excess, while source 3 has a shortage. For part 2, source 2 has a shortage, but neither of source 1 nor source 3 has an excess. For part 3, source 2 has an excess, while source 3 has a shortage. For part 3, source 2 has an excess, and both of sources 3 and 1 have a shortage. As illustrated by the inventory of part 3, a quantity of sources that have a shortage (two—sources 1 and 3) may not be equal to the number of sources having an excess (source 2). As to part 4, both sources 1 and 2 may have an excess, while source 3 has a shortage. As illustrated by the inventory of part 4, a quantity of sources that have an excess (two—sources 1 and 2) may not be equal to the number of sources having an excess (source 3). Step 230 may also include determining an amount of parts that are in excess or shortage among inventory sources 160, and comparing those amounts across the inventory sources 160. For example, lists having information like that in lists 450, 452, and 454 of FIG. 3B may be utilized.

In step 240, a component of system 100, such as computer system 110, may develop a parts transfer list. The parts transfer list may be developed based on the comparison of step 220 and the determinations of step 230. FIGS. 3A and 3B depict exemplary transfer lists, 410 and 456, respectively. Transfer list 410 (FIG. 3A) may include a part number (first column), one or more inventory sources 160 from which to transfer a part (second column), and one or more inventory sources 160 to which to a part may be transferred (third column). Transfer list 456 may include the information shown in transfer list 410, and may also include a quantity of each part to transfer from one or more inventory sources 160 to others of one or more inventory sources 160.

The following discussion provides certain examples of how a transfer list may be compiled in step 240, including example inventory transfer rules. These examples are for illustrative purposes and are not limiting. A transfer list created in step 240 may include any desired information and may be compiled according to any desired rules. Transfer list 456 will be discussed as an example. The principles applying to transfer list 456 may also apply to transfer list 410, because the quantities of transfer list 456 are compatible with the to and from columns of transfer list 410. For ease of discussion, the following examples address the parts in sequential order, from 1 through X. The example rules below may be combined or optimized. Examples of such optimization will be provided herein, but are not limiting.

For part 1, source 1 may have an excess of inventory (e.g., of two parts, as shown in list 450), and source 3 may have a shortage of inventory (e.g., of one part, as shown in list 454). The excess of inventory of source 1 may be greater than the shortage of inventory of source 3. Transfer list 456 may provide that the shortage of inventory of source 3 be satisfied by source 1 (e.g., by transferring one part from source 1 to source 3).

For part 2, although source 2 may have a shortage (e.g., of two parts, as shown in list 452), neither of source 1 nor source 3 may have an excess (as shown in lists 450, 454). Therefore, transfer list 456 may not provide for any transfer of part 2, because a rule may provide that no transfer occurs where there is no inventory source 160 having an excess of inventory. Alternatively, a rule may provide for transfer where no inventory source 160 has an excess, if other priorities take precedence. For example, a transfer may occur in order to prioritize completion of a certain assembly.

For part 3, source 2 may have an excess (e.g., of two parts, as shown in list 452), and source 3 may have an equal shortage (e.g., of two parts, as shown in list 454). Transfer list 456 may provide that the shortage of source 3 be satisfied by a transfer from source 2 (e.g., a transfer of two parts).

For part 4, source 2 may have an excess (e.g., of three parts, as shown in list 452). Source 1 may have a shortage (e.g., of two parts, as shown in list 450), and source 3 may have a shortage (e.g., of 1 part, as shown in list 454). Transfer list 456 may provide that the excess of source 2 be transferred to sources 1 and 3, in order to satisfy the shortages. A rule may provide that excess inventory of an inventory source 160 may be divided among multiple receiving inventory sources 160 having shortages.

As to part 5, source 1 may have an excess (e.g., of two parts, as shown in list 450), and source 3 may also have an excess (e.g., of two parts, as shown in list 454). Source 2 may have a shortage (e.g., of two parts, as shown in list 452). The transfer list may provide that the excess of source 1 may be transferred to source 2 (e.g., two parts may be transferred, as shown in transfer list 456). A rule may provide that, where a transfer is already occurring from a providing source to a receiving source (see part 6, discussed below), a transfer from the providing source will be prioritized over other sources that would not otherwise transfer inventory to the receiving source. In FIG. 3B, source 1 will have a transfer to source 2 (for part 6, discussed below), regardless of the transfer order for part 5. On the other hand, source 3 would not otherwise have a transfer to source 2. Therefore, transfer list 456 may provide that the shortage of source 2 will be satisfied by source 1. Alternatively, other rules may be applied to choose among inventory sources 160 having excesses for a transfer to an inventory source 160 having shortages. For example, rules may optimize the transfer list 456. Such rules may consider, e.g., proximity of inventory sources 160, shortages and excesses following the lead time being considered, etc.

With respect to part 6, source 1 may have an excess (e.g., of three parts, as shown in list 450), and source 2 may have a shortage (e.g., of two parts, as shown in list 452). Transfer list 456 may provide for a transfer from source 1 to source 2 (e.g., of two parts), as shown in transfer list 456. A rule may indicate that only the amount of the shortage should be transferred. Alternatively, an entirety of an excess may be transferred.

As to part 7, source 1 may have a shortage (e.g., of three parts, as shown in list 450). Source 2 may have an excess (e.g., of two parts, as shown in list 452). Source 3 may have an excess (e.g., of one part, as shown in list 454). Transfer list 456 may provide for a transfer from sources 2 and 3 to source 1 (e.g., two parts may be transferred from source 2, and 1 part may be transferred from source 3). A rule may provide that a shortage may be satisfied from a combined excess of two sources. Further rules may optimize an amount of quantity that is transferred from each source (e.g., where the combined excess is greater than the shortage).

With respect to part X, source 1 may have a shortage (e.g., of one part, as shown in list 450). Source 2 may have an excess (e.g., of one part, as shown in list 452). Source 3 may have a shortage (e.g., of one part, as shown in list 454). A rule may provide that, where it is possible to provide an inventory source 160 with each of the parts it needs to build an assembly, that inventory source 160 should be prioritized. After transfer list 456 is executed (as discussed below), source 1 will have sufficient inventory of each of parts 1-X, if it receives a number of part X to satisfy the shortage. The inventory list of source 1 will be completed and/or fully satisfied. However, source 3 will lack part 3, regardless of any transfer of part X. Therefore, transfer list 456 may provide for transfer of part X from source 2 to source 1.

In step 250, a bot may be deployed to complete the transfer provided by the list of step 240. For example, the bot may complete a stock transfer order in SAP. The transfer may enable assembly of a part using the parts 1-X by minimizing shortages at the relevant lead time.

FIG. 2B shows another example method 300. Method 300 may incorporate any of the steps above, described with regard to method 200. Steps of method 300 maybe used in combination with the steps of method 200. A component of system 100 may complete each of the steps of method 200. For example, an inventory management module 114 of computer system 110 may complete each of the steps. Alternatively, other portions of system 100 (including computer system 110) may complete some or all of the steps. Where particularly relevant, portions of system 100 that may complete a given step may be highlighted below.

In step 302, a component of system 100 may determine the parts 1-X that are required. Parts 1-X may be, for example, a list of parts that are needed to construct a particular assembly. Additionally or alternatively, the list of parts 1-X may be a list of all of the parts stored at an inventory source 160. Inventory sources 160 and/or computer system 110 (e.g., inventory management module 114) may complete step 302.

In step 306, a lead time may be determined. Step 306 may utilize any of the techniques of step 210, described above. Step 306 may be completed before or after the list of required parts is determined in step 302. The determined lead time may vary across parts 1-X or may be the same for each of parts 1-X. Inventory sources 160 and/or computer system 110 (e.g., inventory management module 114) may complete step 306.

In step 310, inventory sources 160 may be queried by computer system 110 or another component of computer system 100. Alternatively, where inventory sources 160 are not physical storage locations, inventory sources 160 may query the physical storage locations or computer systems containing information relating to the physical storage locations. Where inventory sources 160 complete steps 302 and/or 306, the data gathered/determined in steps 302 and/or 306 may be obtained by computer system 110 in step 310. Step 310 may include creating a list/database or otherwise compiling information regarding parts in inventory at a relevant lead time (e.g., the lead time determined in step 306).

In step 314, for each of the inventory sources 160, a list of parts may be created for which there is excess inventory at the relevant lead time (e.g., the determined lead time of step 306). Step 314 may include any of the techniques described with respect to step 210 and may produce lists such as those shown in FIGS. 3A and 3B. For example, step 314 may provide the information in the first and second columns of lists 404, 406, 408.

In step 318, for each of the inventory sources 160, a list of parts may be created for which there is a shortage of inventory at the relevant lead time (e.g., the determined lead time of step 306). Step 318 may include any of the techniques described with respect to step 210 and may produce lists such as those shown in FIGS. 3A and 3B. For example, step 318 may provide the information in the first and third columns of lists 404, 406, 408.

FIGS. 3A and 3B show lists 404, 406, 408, 450, 452, 454 having information regarding both excess and shortage of inventory in the same list. In steps 314 and 318, separate lists may be created for each of excess and inventory. For example, two lists may be created for each inventory source 160—one for excess, and one for inventory. For example, with respect to FIGS. 3A and 3B, lists 404, 406, 408, 450, 452, 454 may each be divided into two lists for each of shortages and excess.

In step 322, the lists of excess inventory created in step 314 may be compared to the lists of shortage of inventory created in step 318. Step 322 may include any of the techniques of step 220. Step 322 may include comparing the lists created in steps 314 and 318 on a part-by-part basis. Where the lists of steps 314 and 318 produce one list for excess and one list for inventory for each inventory source, the shortage list for a first inventory source 160 may be compared to the excess lists for the remaining inventory sources. The comparison may be repeated for each of the inventory sources. Alternatively, all of the lists created in steps 314 and 318 may be simultaneously compared or may be compared in any subset.

In step 326, matches may be determined between the lists of excess inventory and lists of shortage inventory. Step 326 may include any of the techniques described above, with respect to step 230. A match may occur where one inventory source 160 has a shortage and another of inventory sources 160 has an excess. As discussed above, matches may be made among more than two inventory sources 160. Excesses and/or shortages may be pooled among inventory sources 160 in order to form matches.

In step 330, a proposed parts transfer list may be developed based on the matches determined in step 326. Step 330 may utilize any of the techniques of step 240 and may result in transfer lists such as transfer lists 410, 456, depicted in FIGS. 3A and 3B.

In step 334, the proposed parts transfer list developed in step 330 may be presented to a user via a user interface. For example, computer system 110 may include a user interface by which the transfer list is presented. The user to whom the list is presented may have an inventory management role. Approval may be sought from one user (e.g., a user of computer system 110) or from multiple users (e.g., users associated with inventory sources 160). Each item on the proposed transfer list may be presented to the user. Alternatively, only a subset of items may be presented to the user (e.g., high-value items, high-demand items, specialty items, low-inventory items, etc.). An entirety of the proposed parts transfer list may be presented at one time, or subsets of the parts transfer list may be presented sequentially.

In step 338, a user may approve or disapprove of the proposed transfer list of step 330 that is presented in step 334. The user may approve or disapprove of an entirety of the transfer list or a subset of the transfer list. For example, the user may approve or disapprove the transfer list on a part-by-part basis or a category-by-category basis. The user's approval or disapproval may be tentative (e.g., subject to further approval) or may be final.

In step 342, if the user does not approve of the parts transfer in step 338, then the transfer may not be completed. Depending on the decisions of the user in step 338, an entirety of the transfer may not be completed. Alternatively, only portions of the transfer may not be completed. A user's determinations in step 338 may cause certain other automated determinations to complete or not complete a parts transfer. For example, if the user related to one of inventory sources 160 declines a transfer, the transfers to/from others of inventory sources 160 may be affected and may require adjustment.

If, in step 338, the user approves of the parts transfer, a bot may be deployed to complete the part transfer in step 346. As explained above, with respect to step 342, varying approvals and disapprovals of subsets of a master transfer list (a transfer list of all proposed transfers) may be interrelated. An approved transfer may not be completed in step 346 if certain other transfers are disapproved.

Any of the steps in any of the methods described above may involve optimizing transfers among multiple inventory sources 160. For example, a number of transfers may be minimized, transfers may be consolidated, and an ability to construct a complete assembly may be prioritized. Potential shortages and/or excesses after the lead time of interest may also be considered in developing a transfer list. For example, if an inventory source 160 has an excess at a first lead time but would have a shortage or a lack of excess at a second lead time, shortly after the first lead time, a transfer from that inventory source 160 to another inventory source 160 may not be completed. The systems and methods described above may minimize a number of trips between physical inventory storage locations by simultaneously considering inventory statuses at multiple lead times.

FIG. 4 depicts an example system that may execute techniques presented herein. FIG. 5 is a simplified functional block diagram of a computer that may be configured to execute techniques described herein, according to exemplary embodiments of the present disclosure. Specifically, the computer (or “platform” as it may not be a single physical computer infrastructure) may include a data communication interface 560 for packet data communication. The platform may also include a central processing unit (“CPU”) 520, in the form of one or more processors, for executing program instructions. The platform may include an internal communication bus 510, and the platform may also include a program storage and/or a data storage for various data files to be processed and/or communicated by the platform such as ROM 530 and RAM 540, although the system 500 may receive programming and data via network communications. The system 500 also may include input and output ports 550 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method for inventory management, the method comprising:
creating, by a processor, a plurality of lists of inventory excess and inventory shortage, wherein each of the plurality of lists corresponds to an inventory source of a plurality of inventory sources;
comparing the plurality of lists to one another;
determining instances in which at least a first of the plurality of inventory sources has an inventory excess and at least a second of the plurality of inventory sources has an inventory shortage;
developing a transfer list; and
executing the transfer list to complete at least one transfer.

2. The computer-implemented method of claim 1, further comprising determining a lead time.

3. The computer-implemented method of claim 2, wherein the plurality of lists include the inventory excess and the inventory shortage at the determined lead time.

4. The computer-implemented method of claim 1, further comprising presenting the transfer list to a user for approval.

5. The computer-implemented method of claim 1, wherein executing the transfer list includes deploying a bot.

6. The computer-implemented method of claim 1, wherein developing the transfer list includes applying at least one inventory transfer rule.

7. The computer-implemented method of claim 1, further comprising receiving information from the plurality of inventory sources regarding the inventory excess and the inventory shortage of each of the plurality of inventory sources.

8. The computer-implemented method of claim 1, further comprising optimizing the transfer list based on at least one of: a number of the transfers required, inventory requirements after a lead time, or satisfying the inventory requirements of an inventory source.

9. A system for executing a method for inventory management, the method comprising:
creating, by a processor, a plurality of lists of inventory excess and inventory shortage, wherein each of the plurality of lists corresponds to an inventory source of a plurality of inventory sources;
comparing the plurality of lists to one another;
determining instances in which at least a first of the plurality of inventory sources has an inventory excess and at least a second of the plurality of inventory sources has an inventory shortage;
developing a transfer list; and
executing the transfer list to complete at least one transfer.

10. The system of claim 9, wherein the method further comprises determining a lead time.

11. The system of claim 10, wherein the plurality of lists include the inventory excess and the inventory shortage at the determined lead time.

12. The system of claim 9, wherein the method further comprises presenting the transfer list to a user for approval.

13. The system of claim 9, wherein executing the transfer list includes deploying a bot.

14. The system of claim 9, wherein developing the transfer list includes applying at least one inventory transfer rule.

15. The system of claim 1, wherein the method further comprises receiving information from the plurality of inventory sources regarding the inventory excess and the inventory shortage of each of the plurality of inventory sources.

16. The system of claim 9, wherein the method further comprises optimizing the transfer list based on at least one of: a number of the transfers required, inventory requirements after a lead time, or satisfying the inventory requirements of an inventory source.

17. A non-transitory computer-readable medium containing instructions for inventory management, the instructions comprising a method for:
creating, by a processor, a plurality of lists of inventory excess and inventory shortage, wherein each of the plurality of lists corresponds to an inventory source of a plurality of inventory sources;
comparing the plurality of lists to one another;
determining instances in which at least a first of the plurality of inventory sources has an inventory excess and at least a second of the plurality of inventory sources has an inventory shortage;
developing a transfer list; and
executing the transfer list to complete at least one transfer.

18. The non-transitory computer-readable medium of claim 17, wherein the method further comprises determining a lead time.

19. The non-transitory computer-readable medium of claim 18, wherein the plurality of lists include the inventory excess and the inventory shortage at the determined lead time.

20. The non-transitory computer-readable medium of claim 17, wherein the method further comprises receiving information from the plurality of inventory sources regarding the inventory excess and the inventory shortage of each of the plurality of inventory sources.
